(19) United States
(12) Patent Application Publication
(10) Pub. No.: US 2023/0150533 A1
(43) Pub. Date: May 18, 2023

(54) VEHICLE CONTROL SYSTEM AND VEHICLE DRIVING METHOD USING THE VEHICLE CONTROL SYSTEM

(71) Applicant: HYUNDAI MOBIS Co., Ltd., Seoul (KR)

(72) Inventor: Kyung Jung SONG, Yongin-si (KR)

(73) Assignee: HYUNDAI MOBIS Co., Ltd., Seoul (KR)

(21) Appl. No.: 17/964,939

(22) Filed: Oct. 13, 2022

(30) Foreign Application Priority Data
Nov. 16, 2021 (KR) 10-2021-0158006
Nov. 16, 2021 (KR) 10-2021-0158007

(51) Int. Cl. B60W 60/00; B60W 50/14

(52) U.S. Cl. CPC B60W 60/001; B60W 50/14; B60W 2556/40; B60W 2552/30; B60W 2420/42

(57) ABSTRACT

The vehicle control system includes a processor that processes data related to driving of a vehicle, an input device for receiving a user input for controlling a driving function of the vehicle, a sensing device for acquiring data related to the driving of the vehicle from the vehicle and an external environment, and an output device for providing information related to the driving of the vehicle, wherein the processor initiates an autonomous driving mode, measures a difference value between a route of a sparse map and a route of a sensed data acquired using the sensing device, controls the output device to output a first warning based on the difference value, and controls the output device to output a second warning having a higher level than a level of the first warning, and end the autonomous driving mode based on the user input.

### CROSS-REFERENCE TO RELATED APPLICATION

This application claims the benefit of priority to Korean Patent Application No. 10-2021-0158006, filed in the Korean Intellectual Property Office on Nov. 16, 2021 and Korean Patent Application No. 10-2021-0158007, filed in the Korean Intellectual Property Office on Nov. 16, 2021, the entire contents of which are incorporated herein by reference.

### TECHNICAL FIELD

The present disclosure relates to a vehicle control system and a vehicle driving method using the vehicle control system, and more particularly, to an autonomous driving technology that improves accuracy of a target travel route.

### BACKGROUND

Autonomous driving technology in which a travel route of a vehicle is set and the vehicle travels according to the set travel route while the driver does not drive the vehicle directly is emerging. Autonomous driving technology may be implemented in a scheme of acquiring route information on the travel route, setting the travel route based on the obtained route information, and driving the vehicle according to the set route.

### SUMMARY

According to the existing autonomous driving technology, it may not be easy to set an accurate travel route for various situations.

The present disclosure has been made to solve the above-mentioned problems occurring in the prior art while advantages achieved by the prior art are maintained intact.

An aspect of the present disclosure provides a technique for setting an accurate travel route for various situations.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control system includes a processor that processes data related to driving of a vehicle, an input device for receiving a user input for controlling a driving function of the vehicle, a sensing device for acquiring data related to the driving of the vehicle from the vehicle and an external environment, and an output device for providing information related to the driving of the vehicle, wherein the processor initiates an autonomous driving mode, measures a difference value between a route of a sparse map and a route of a sensed data acquired using the sensing device, controls the output device to output a first warning based on the difference value, and controls the output device to output a second warning having a higher level than a level of the first warning, and end the autonomous driving mode based on the user input.

According to an aspect of the present disclosure, a vehicle control system includes a processor that process data related to driving of a vehicle, and a vehicle controller that control the driving of the vehicle. The processor sets a trajectory along which the vehicle travels as a target trajectory when the vehicle is positioned at a reference position, detects a current position of the vehicle, corrects a position of the vehicle such that the vehicle is positioned at a median of a lane, and generates a plurality of routes based on the corrected position of the vehicle and the target trajectory.

According to an aspect of the present disclosure, a method for driving a vehicle using a vehicle control system includes initiating an autonomous driving mode, measuring a difference value between a route of a sparse map and a route of sensed data acquired using a sensing device of the vehicle control system, controlling an output device of the vehicle control system to output a first warning based on the difference value, and controlling the output device to output a second warning having a higher level than a level of the first warning, and ending the autonomous driving mode.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing a vehicle control system according to one embodiment of the present disclosure;

FIG. 2 is a view showing a position at which a camera of a vehicle control system according to one embodiment of the present disclosure is disposed on a vehicle;

FIG. 3 is a view showing a position at which a camera of a vehicle control system according to one embodiment of the present disclosure is disposed on a vehicle;

FIG. 4 is a view showing a position at which a camera of a vehicle control system according to one embodiment of the present disclosure is disposed on a vehicle;

FIG. 5 is a view showing a position in which a camera of a vehicle control system according to one embodiment of the present disclosure is disposed on a vehicle;

FIG. 6 is a view showing a plurality of camera devices of a vehicle control system according to one embodiment of the present disclosure;

FIG. 7 is a view showing a plurality of camera devices of a vehicle control system according to one embodiment of the present disclosure;

FIG. 8 is a block diagram showing a sparse map of a processor according to one embodiment of the present disclosure;

FIG. 9 is a diagram showing a polynomial expression of a trajectory according to one embodiment of the present disclosure;

FIG. 10 is a diagram showing a landmark according to one embodiment of the present disclosure;

FIG. 11 is a flowchart showing a method in which a vehicle control system according to one embodiment of the present disclosure generates a sparse map;

FIG. 12 is a flowchart showing a method for anonymizing navigation information by a vehicle control system according to one embodiment of the present disclosure;

FIG. 13 is a flowchart showing a method in which a vehicle control system according to one embodiment of the present disclosure compares a trajectory generated using a road navigation model with sensed data and controlling an autonomous driving mode based on the comparing result;

FIG. 14 is a flowchart showing a method in which a vehicle control system according to one embodiment of the present disclosure compares a route recognized using a sparse map with a route recognized using sensed data and controlling an autonomous driving mode based on the comparing result;

FIG. 15 is a diagram showing that a vehicle control system according to one embodiment of the present disclosure corrects a route generated based on a target trajectory, based on a vehicle position;

### DETAILED DESCRIPTION

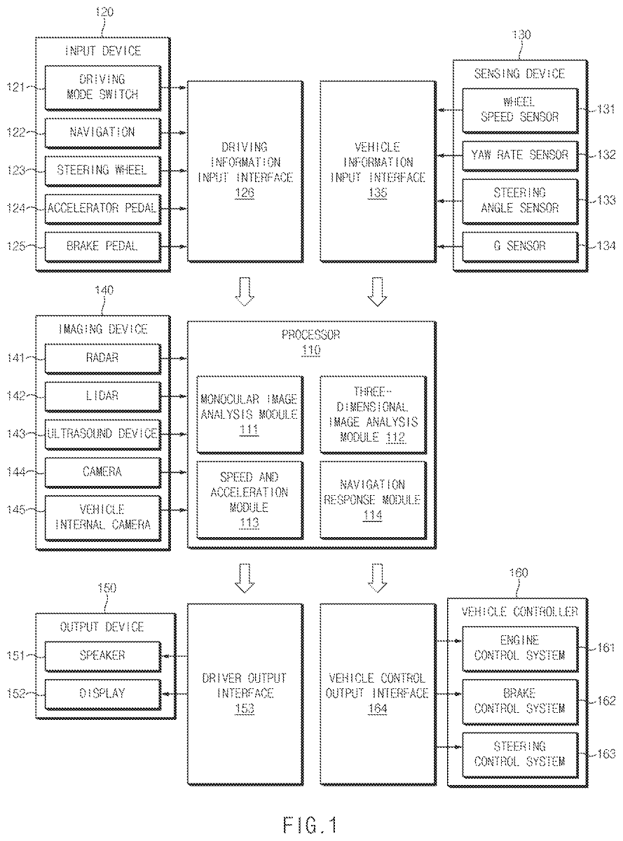

FIG. 1 is a block diagram showing a vehicle control system according to one embodiment of the present disclosure.

The vehicle control system according to one embodiment may include a processor 110, an input device 120, a sensing device 130, an imaging device 140, an output device 150, and a vehicle controller 160.

The processor 110 and the vehicle controller 160 of the vehicle control system according to an exemplary embodiment of the present disclosure may be a hardware device implemented by various electronic circuits (e.g., computer, microprocessor, CPU, ASIC, circuitry, logic circuits, etc.). The processor and the vehicle controller 160 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory, the processor 110 and the vehicle controller 160 may be implemented as separate semiconductor circuits. Alternatively, the memory, the processor 110 and the vehicle controller 160 may be implemented as a single integrated semiconductor circuit. The processor 110 may embody one or more processor(s). The vehicle controller 160 may embody one or more processor(s).

The processor 110 may realize autonomous driving by processing data related to driving of a vehicle. The processor 110 may include a monocular image analysis module 111, a three-dimensional image analysis module 112, a speed and acceleration module 113, and a navigation response module 114.

The monocular image analysis module 111 may analyze a monocular image of an image set acquired by the imaging device 140. The monocular image analysis module 111 may merge data included in the image set with other types of data acquired by the imaging device 140 to perform monocular image analysis. The monocular image analysis module 111 may detect, within the image set, features such as a lane marking, a vehicle, a pedestrian, a road sign, a highway interchange, a traffic light, a risk object, and other feature related to the vehicle's surroundings. The processor 110 of the vehicle control system may cause at least one navigation response such as rotation, lane change, or acceleration change of the vehicle, based on the analysis result of the monocular image analysis module 111.

The three-dimensional image analysis module 112 may combine data acquired from the imaging device 140 and data acquired from the sensing device 130 with each other and perform analysis thereon. The three-dimensional image analysis module 112 may perform three-dimensional image analysis. The three-dimensional image analysis module 112 may implement a method related to a neural network learning system, a deep neural network learning system, or a non-learning system that utilizes a computer vision algorithm to detect and/or label an object in a context of capturing and processing sensed information. The three-dimensional image analysis module 112 may employ a combination of a learning system and a non-learning system.

The speed and acceleration module 113 may control change in a speed and/or an acceleration of the vehicle. The speed and acceleration module 113 may calculate a target speed of the vehicle based on data obtained from the monocular image analysis module 111 and/or the three-dimensional image analysis module 112. The data obtained from the monocular image analysis module 111 and/or the three-dimensional image analysis module 112 may include a target position, a speed, an acceleration, the vehicle's position and/or speed with respect to a surrounding vehicle, a pedestrian or an object on a road, and position information of the vehicle for lane indication of the road. The speed and acceleration module 113 may transmit a speed control signal to the vehicle controller 160 based on the calculated target speed.

The navigation response module 114 may determine a necessary navigation response based on the data obtained from the monocular image analysis module 111, the three-dimensional image analysis module 112, and the input device 120. The data obtained from the monocular image analysis module 111, the three-dimensional image analysis module 112, and the input device 120 may include a position and a speed of the vehicle with respect to a surrounding vehicle, a pedestrian, and an object on a road, and target position information of the vehicle. The navigation response may be determined based on map data, preset vehicle position, a relative speed or a relative acceleration between the vehicle and at least one object. The navigation response module 114 may transmit a navigation control signal to the vehicle controller 160 based on a navigation response determined as being necessary. For example, the navigation response module 114 may generate the necessary navigation response by rotating the vehicle's steering handle to induce rotation by a preset angle. The navigation response determined to be necessary by the navigation response module 114 may be used as data input to the speed and acceleration module 113 to calculate a speed change of the vehicle.

The input device 120 may receive a user input for controlling a driving function. The input device 120 may include a driving mode switch 121, a navigation 122, a steering wheel 123, an accelerator pedal 124, and a brake pedal 125. The input device 120 may transmit the user input to the processor 110 through a driving information input interface 126.

The sensing device 130 may acquire data related to driving of the vehicle from the vehicle and an external environment. The sensing device 130 may include a wheel speed sensor 131, a yaw rate sensor 132, a steering angle sensor 144, and a G sensor 134. The sensing device 130 may transmit the acquired data to the processor 110 through a vehicle information input interface 135.

The imaging device 140 may detect and image an external environment. The imaging device 140 may include a radar 141, a lidar 142, an ultrasound device 143, a camera 144, and a vehicle internal camera 145. The imaging device 140 may transmit the sensed and imaged external environment to the processor 110.

The output device 150 may provide information related to driving of the vehicle to an occupant including the driver. The output device 150 may include a speaker 151 and a display 152. The output device 150 may provide information related to driving of the vehicle output from the processor 110 through a driver output interface 153 to the occupant.

The vehicle controller 160 may control driving of the vehicle. The vehicle controller 160 may include an engine control system 161, a brake control system 162, and a steering control system 163. The vehicle controller 160 may receive driving control information output from the processor 110 through a vehicle control output interface 164 to control driving of the vehicle.

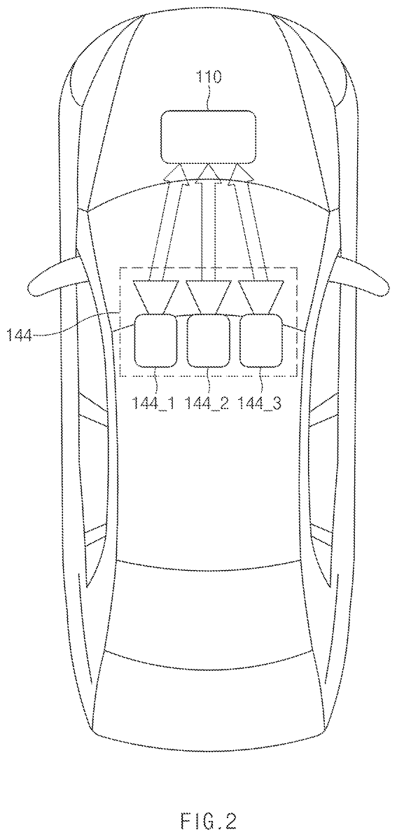

FIG. 2 is a view showing the position in which a camera of the vehicle control system according to one embodiment of the present disclosure is disposed on the vehicle.

A camera 144 may include a first camera device 144_1, a second camera device 144_2, and a third camera device 144_3. The first camera device 144_1, the second camera device 144_2, and the third camera device 144_3 may be arranged side by side in a width direction of the vehicle. The first camera device 144_1, the second camera device 144_2, and the third camera device 144_3 may be disposed around a rear view mirror of the vehicle and/or adjacent to a driver seat. At least portions of field of views (FOV) of the first camera device 144_1, the second camera device 144_2, and the third camera device 144_3 may overlap each other.

The camera 144 may image an external environment. The camera 144 may fuse image information imaged by the first camera device 144_1, the second camera device 144_2, and the third camera device 144_3 with each other. The camera 144 may acquire a three-dimensional image using differences between field of views (FOV) thereof based on differences between positions of the first camera device 144_1, the second camera device 144_2, and the third camera device 144_3. The camera 144 may transmit image data of the external environment as captured to the processor 110.

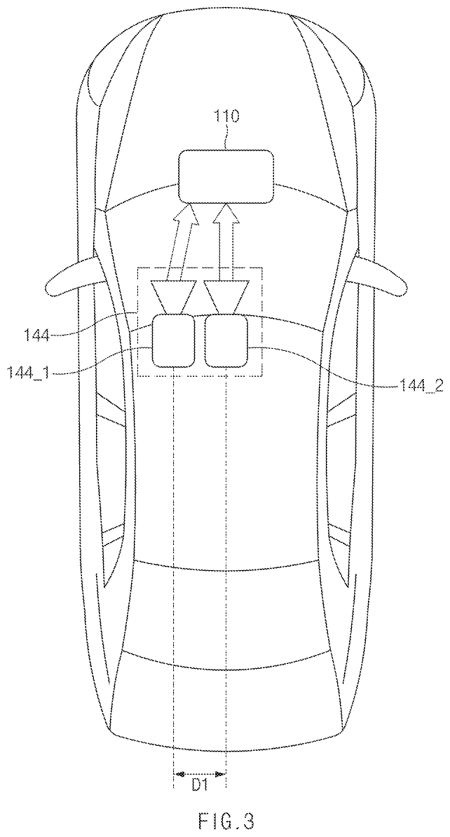

FIG. 3 is a view showing a position in which a camera of the vehicle control system according to one embodiment of the present disclosure is disposed on the vehicle.

The camera 144 may include the first camera device 144_1 and the second camera device 144_2. The first camera device 144_1 and the second camera device 144_2 may be arranged side by side in the width direction of the vehicle. The first camera device 144_1 and the second camera device 144_2 may be arranged around the rear view mirror of the vehicle and/or adjacent to the driver seat. At least portions of field of views (FOV) of the first camera device 144_1 and the second camera device 144_2 may overlap each other. The first camera device 144_1 and the second camera device 144_2 may be spaced apart from each other by a first distance D1 in the width direction of the vehicle.

The camera 144 may image an external environment. The camera 144 may fuse image information imaged by the first camera device 144_1 and the second camera device 144_2 with each other. The camera 144 may acquire a three-dimensional image using a difference between the field of views (FOV) thereof based on a difference between positions of the first camera device 144_1 and the second camera device 144_2. The camera 144 may transmit the image data of the external environment as captured to the processor 110.

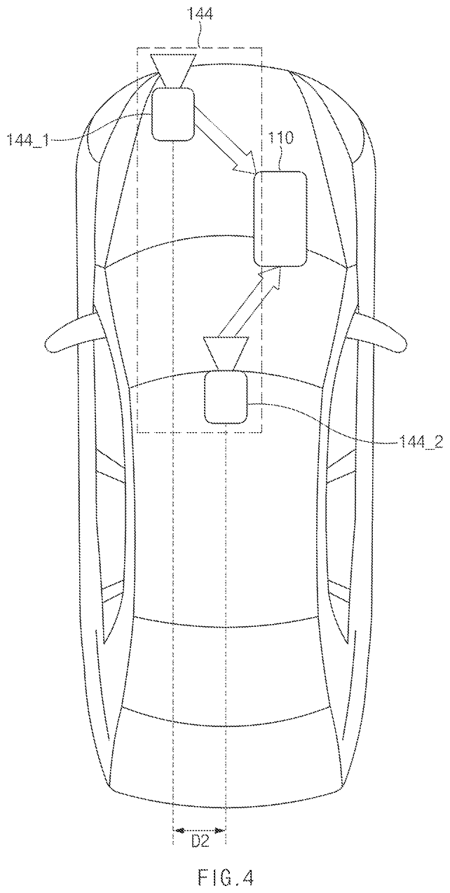

FIG. 4 is a view showing a position in which a camera of the vehicle control system according to one embodiment of the present disclosure is disposed on the vehicle.

The camera 144 may include the first camera device 144_1, the second camera device 144_2, and the third camera device 144_3. The first camera device 144_1 may be disposed above a bumper area of the vehicle or inside the bumper area. The first camera device 144_1 may be disposed adjacent to any one of corners of the bumper area. The second camera device 144_2 may be disposed around the rear view mirror of the vehicle and/or adjacent to the driver seat. At least portions of field of views (FOV) of the first camera device 144_1 and the second camera device 144_2 may overlap each other. The first camera device 144_1 and the second camera device 144_2 may be spaced apart from each other by a second distance D2 in the width direction of the vehicle.

The camera 144 may image an external environment. The camera 144 may fuse image information imaged by the first camera device 144_1 and the second camera device 144_2 with each other. The camera 144 may acquire a three-dimensional image using a difference between the field of views (FOV) thereof based on a difference between positions of the first camera device 144_1 and the second camera device 144_2. The camera 144 may transmit the image data of the external environment as captured to the processor 110.

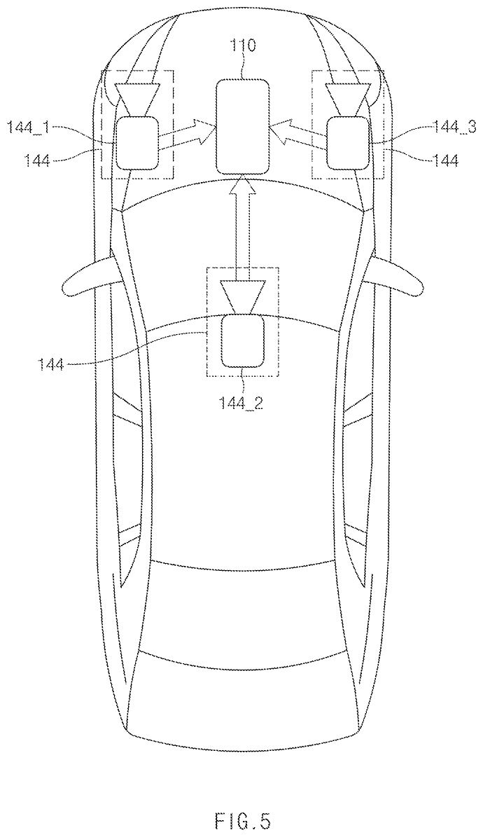

FIG. 5 is a view showing a position in which a camera of the vehicle control system according to one embodiment of the present disclosure is disposed on the vehicle.

The camera 144 may include the first camera device 144_1, the second camera device 144_2, and the third camera device 144_3. The first camera device 144_1 and the third camera device 144_3 may be disposed above or inside the bumper area of the vehicle. The first camera device 144_1 may be disposed adjacent to any one of the corners of the bumper area. The third camera device 144_3 may be disposed adjacent to a corner of the bumper area except for the corner where the first camera device 144_1 is disposed. The second camera device 144_2 may be disposed around the rear view mirror of the vehicle and/or adjacent to the driver seat. At least portions of field of views (FOV) of the first camera device 144_1, the second camera device 144_2, and the third camera device 144_3 may overlap each other.

The camera 144 may image an external environment. The camera 144 may fuse image information imaged by the first camera device 144_1, the second camera device 144_2, and the third camera device 144_3 with each other. The camera 144 may acquire a three-dimensional image using differences between field of views (FOV) based on differences between positions of the first camera device 144_1, the second camera device 144_2, and the third camera device 144_3. The camera 144 may transmit the image data of the external environment as captured to the processor 110.

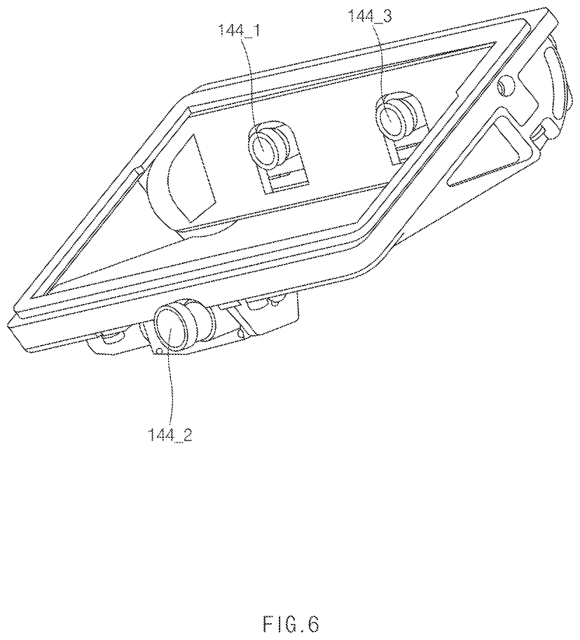

FIG. 6 is a view showing a plurality of camera devices of the vehicle control system according to one embodiment of the present disclosure.

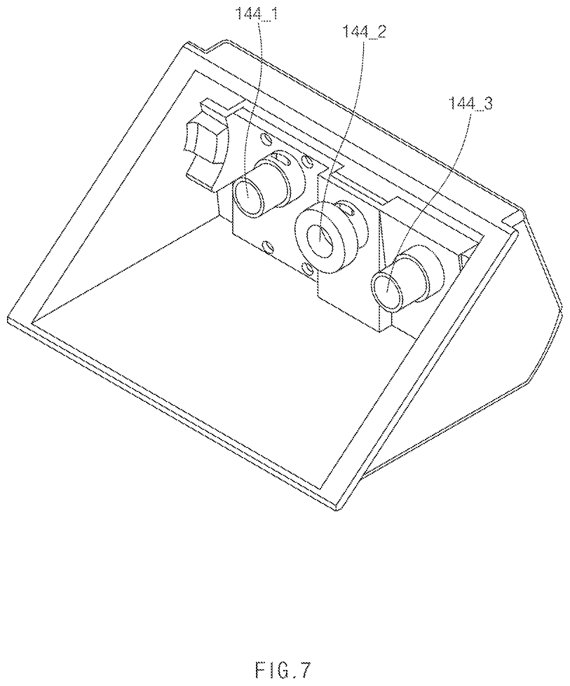

The plurality of camera devices may include the first camera device 144_1, the second camera device 144_2, and the third camera device 144_3. FIG. 7 is a view showing a plurality of camera devices of a vehicle control system according to one embodiment of the present disclosure. The plurality of camera devices may include the first camera device 144_1, the second camera device 144_2, and the third camera device 144_3.

Each of the first camera device 144_1, the second camera device 144_2, and the third camera device 144_3 may include an image capture device of an appropriate type. The image capture device may include an optical axis. The image capture device may include an Aptina M9V024 WVGA sensor of a global shutter scheme. The image capture device may provide a resolution of 1280×960 pixels and may include a rolling shutter scheme. The image capture device may include a variety of optical elements. The image capture device may include at least one lens to provide a focal length and a field of view (FOV) required by the image capture device. The image capture device may be combined with a 6 mm lens or a 12 mm lens.

Each of the first camera device 144_1, the second camera device 144_2, and the third camera device 144_3 may have a designated field of view (FOV) angular range. Each of the first camera device 144_1, the second camera device 144_2, and the third camera device 144_3 may have a general field of view (FOV) angular range of 40 degrees or greater and 56 degrees or smaller. Each of the first camera device 144_1, the second camera device 144_2, and the third camera device 144_3 may have a narrow field of view (FOV) angular range of 23 degrees or greater and 40 degrees or smaller. Each of the first camera device 144_1, the second camera device 144_2, and the third camera device 144_3 may have a wide FOV (field of view) angular range of 100 degrees or greater and 180 degrees or smaller. Each of the first camera device 144_1, the second camera device 144_2, and the third camera device 144_3 may include a wide-angle bumper camera or a camera capable of securing up to a 180-degree field of view (FOV). The field of view (FOV) of the first camera device 144_1 may be wider, narrower, or partially overlapping than the field of view (FOV) of the second camera device 144_2.

A 7.2 megapixel image capture device with an aspect ratio of about 2:1 (e.g., H×V=3800×1900 pixels) and a horizontal field of view (FOV) of about 100 degrees may replace a configuration of a plurality of camera device composed of the first camera device 144_1, the second camera device 144_2, and the third camera device 144_3. A vertical field of view (FOV) of a megapixel image capture device using a radially symmetrical lens may be realized to be 50 degrees or smaller due to lens distortion. A radially asymmetric lens may be used to achieve a vertical field of view (FOV) of 50 degrees or greater for a horizontal field of view (FOV) of 100 degrees.

A driving support function may be provided using a multi-camera system including a plurality of camera devices. The multi-camera system may use at least one camera facing in a front direction of the vehicle. In the multi-camera system, at least one camera may face in a side direction or a rear direction of the vehicle. The multi-camera system may be configured so that the first camera device 144_1 and the second camera device 144_2 face in the front direction and/or the side direction of the vehicle using a dual-camera imaging system.

The multi-camera systems including the plurality of camera devices may employ a triple camera imaging system in which FOVs (field of view) of the first camera device 144_1, the second camera device 144_2, and the third camera device 144_3 are different from each other. The triple-camera imaging system may perform determinations based on information obtained from objects positioned at various distances in the front and side directions of the vehicle.

The first camera device 144_1 may be connected to a first image processor to perform monocular image analysis of an image provided by the first camera device 144_1. The second camera device 144_2 may be connected to a second image processor to perform monocular image analysis of an image provided by the second camera device 144_2. Information processed and output by the first and the second image processors may be combined with each other. The second image processor may receive images from both the first camera device 144_1 and the second camera device 144_2 and perform three-dimensional analysis thereon. Monocular image analysis may mean image analysis performed based on an image captured from a single field of view (e.g., an image captured by a single camera). The three-dimensional image analysis may mean image analysis performed based on two or more images captured with at least one image capture parameter (e.g., images captured respectively by at least two cameras). Captured images suitable for three-dimensional image analysis may include images captured from at least two positions, images captured from different fields of views (FOV), images captured using different focal lengths, and images captured based on parallax information.

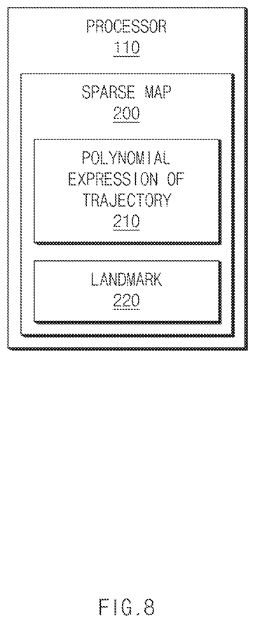

FIG. 8 is a block diagram showing a sparse map of a processor according to one embodiment of the present disclosure.

The processor 110 may include a sparse map 200. The sparse map 200 may be used for autonomous driving. The sparse map 200 may provide information for navigation of autonomous driving vehicles. The sparse map 200 and the data processed by the sparse map 200 may be stored in a memory of the vehicle control system or may be transmitted/received to/from a remote server. The sparse map 200 may store therein and use a polynomial expression of at least one trajectory along which the vehicle travels on a road. In the sparse map 200, a feature of a road section may be simplified and may be recognized as an object. The sparse map 200 may reduce an amount of data stored and transmitted/received for autonomous driving vehicle navigation. The sparse map 200 may include a polynomial expression 210 of a trajectory and a landmark 220.

The polynomial expression 210 of the trajectory may be a polynomial expression of a target trajectory for guiding autonomous driving along a road section. The target trajectory may represent an ideal route for a vehicle to travel in a road section. The road section may be expressed with at least one target trajectory. The number of target trajectories may be smaller than the number of a plurality of lines included in the road section. A vehicle operating on a road may determine navigation in consideration of a line corresponding to the target trajectory and a line offset using one of the target trajectories.

The landmark 220 may be a place or a mark associated with a specific road section or a local map. The landmark 220 may be identified and stored in the sparse map 200. A spacing between landmarks 220 may be adjusted. The landmark 220 may be used for autonomous driving navigation. The landmark 220 may be used to determine the vehicle's current position with respect to the stored target trajectory. An autonomous driving vehicle may adjust a travel direction at a current position so as to coincide with a direction of the target trajectory using the vehicle's current position information.

The landmark 220 may be used as a reference point for determining a position of the vehicle with respect to the target trajectory. While the vehicle drives based on dead reckoning in which the vehicle determine its itself-movement and estimates its position with respect to the target trajectory, the vehicle may eliminate an error in a position determination due to the dead reckoning, using a position of the landmark 220 that appears in the sparse map 200. The landmark 220 identified in the sparse map 200 may act as an anchor to allow the vehicle to accurately determine the vehicle's position with respect to the target trajectory.

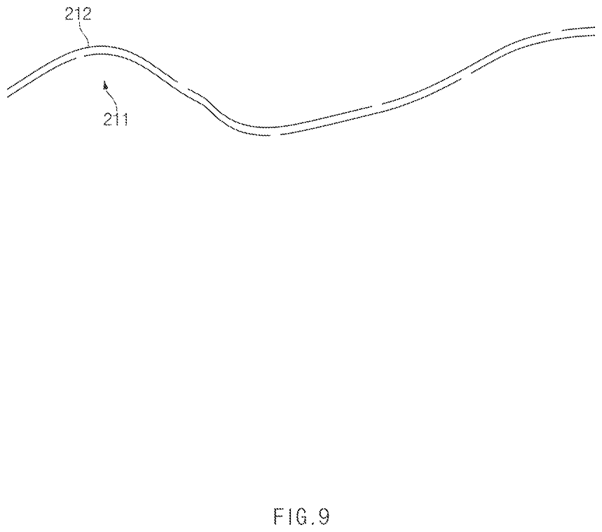

FIG. 9 is a diagram showing the polynomial expression of the trajectory according to one embodiment of the present disclosure.

The sparse map may include information about a feature of a road. The sparse map may store therein a curved shape in sections 212 included in a road 211. Each of the sections 212 may have a curved shape that may be expressed as a polynomial. The road 211 may be modeled as a three-dimensional polynomial expression as a combination of the curved shapes of the lines, each line including left and right sides. A plurality of polynomials may be used to express a position and a shape of the road 211 and each of the sections 212 included in the road 211. A polynomial expressing each of the sections 212 may define a position and a shape of the section 212 within a specified distance.

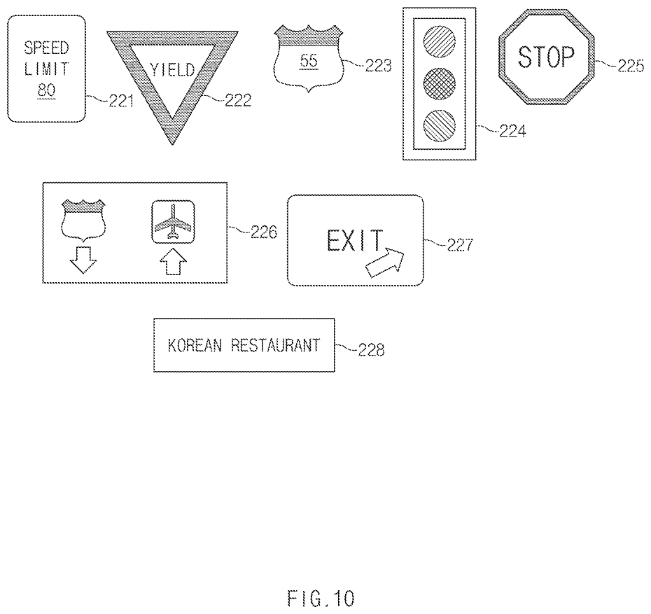

FIG. 10 is a diagram showing a landmark according to one embodiment of the present disclosure.

The landmarks may include a traffic sign plate, a direction indication sign plate, roadside facilities, and a general sign plate. The traffic sign plate may be a sign plate that guides traffic conditions and regulations to be observed during driving. The traffic sign plate may include a speed limit sign plate 221, a yield sign plate 222, a road number sign plate 223, a traffic signal sign plate 224, and a stop sign plate 225. The direction indication sign plate may be a sign plate with at least one arrow indicating at least one direction to another location. The direction indication sign plate may include a highway sign plate 226 with an arrow guiding the vehicle to another road or location and an exit sign plate 227 with an arrow guiding the vehicle out of the road. The general sign plate may be a sign plate that provides information related to a place. The general sign plate may include a signboard 228 of a famous restaurant in an area.

The sparse map may include a plurality of landmarks related to the road section. A simplified image of an actual image of each landmark may be stored in the sparse map. The simplified image may be composed of data depicting a feature of the landmark. The image stored in the sparse map may be expressed and recognized using a smaller amount of data than an amount of data required by the actual image. Data representing the landmark may include information to depicting or identify the landmark formed along the road.

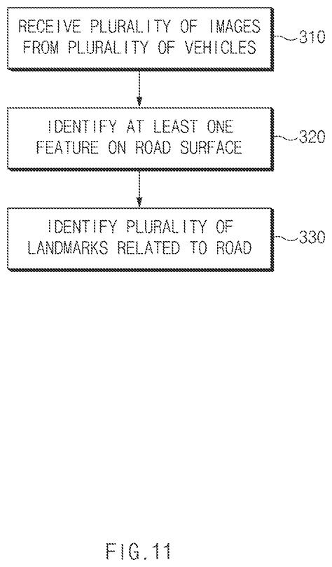

FIG. 11 is a flowchart showing a method of generating a sparse map according to one embodiment of the present disclosure.

The vehicle control system may receive a plurality of images from a plurality of vehicles in operation 310. Each of the plurality of cameras disposed on the vehicle may image a vehicle surrounding situation which the vehicle faces while driving along the road section and thus may capture a plurality of images showing the vehicle surrounding situation. The plurality of images showing the vehicle surrounding situation may show a shape and a situation of the vehicle's travel route. The vehicle control system may receive the plurality of images captured by the plurality of cameras.

The vehicle control system may identify at least one feature on a road surface in operation 320. The vehicle control system may simplify a feature of the road surface running along the road section as a representation of at least one line, based on the plurality of images. The simplified line representation of the feature of the road surface may represent a route along the road section substantially corresponding to the road surface feature. The vehicle control system may analyze the plurality of images received from the plurality of cameras to identify an edge or a lane mark of a road. The vehicle control system may determine a driving trajectory following a road section associated with the edge of the road or the lane mark thereof. A trajectory or line representation may include a spline, a polynomial expression, or a curve. The vehicle control system may determine the vehicle's driving trajectory based on the camera's itself-movement, such as 3D translation and/or 3D rotational movement.

The vehicle control system may identify a plurality of landmarks related to the road in operation 330. The vehicle control system may analyze the plurality of images received from the camera to identify at least one landmark on the road section. The landmarks may include the traffic sign plate, the direction indication sign plate, the roadside facilities, and the general sign plate. The analysis may include a rule for admitting and rejecting a determination that the landmark may be a landmark related to a road section. The analysis may include a rule in which when a ratio of images in which the landmark appears to images in which no landmark appears exceeds a threshold value, the determination that the landmark may be a landmark related to a road section is admitted, and a rule in which when a ratio of images in which no landmark appears to images in which the landmark appears exceeds a threshold value, the determination that the landmark may be a landmark related to a road section is rejected.

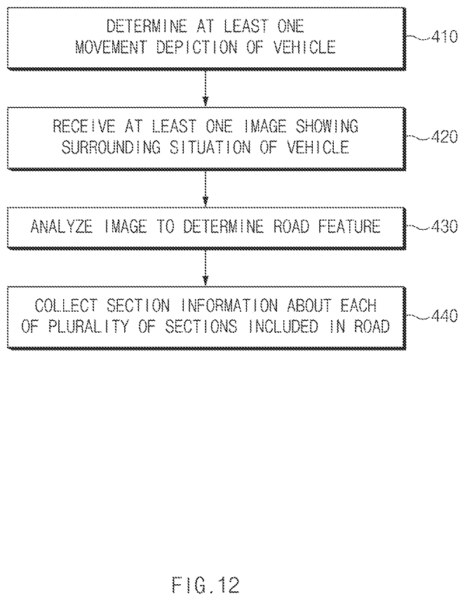

FIG. 12 is a flowchart showing a method in which the vehicle control system according to one embodiment of the present disclosure anonymize navigation information.

The vehicle control system may determine at least one movement depiction of the vehicle in operation 410. The vehicle control system may determine at least one movement depiction based on an output value of the sensor. At least one movement description may include any indicator of the vehicle's movement. For example, at least one movement depiction may include an acceleration of the vehicle, a speed of the vehicle, longitudinal and transversal positions of the vehicle at a specific time, a three-dimensional position of the vehicle, and a determined trajectory of the vehicle.

At least one movement depiction may include the vehicle's itself-movement depiction in a predetermined coordinate system. The itself-movement may include rotation, translation, or movement in a transverse direction, longitudinal direction, or other directions of the vehicle. The vehicle's itself-movement may be expressed using a speed, a yaw rate, a tilt or a roll of the vehicle. A self-movement depiction of the vehicle may be determined on a given level of freedom.

The vehicle control system may receive at least one image showing the surrounding situation of the vehicle in operation 420. The vehicle control system may receive, from the camera, an image of the road on which the vehicle is driving and an image of a surrounding around the vehicle.

The vehicle control system may analyze the image to determine a road feature in operation 430. The vehicle control system may analyze at least one image according to a command stored in the image analysis module, or utilize a learning system such as a neural network to determine at least one road feature. At least one road feature may include a road feature such as a median line of the road, an edge of the road, a landmark along the road, a pothole on the road, a turn of the road, or the like. At least one road feature may include a lane feature including an indicator indicating at least one of lane separation, lane merging, dashed-line lane indication, solid-line lane indication, a road surface color in a lane, a line color, a lane direction, or a lane type regarding a lane as detected. The lane feature may include a determination that the lane is a HOV (High-Occupancy Vehicles) lane and a determination that the lane is separated from another lane by a solid line. At least one road feature may include an indicator of a road edge. The road edge may be determined based on a detected barrier along the road edge, a detected sidewalk, a line indicating an edge, a road boundary stone along the road edge, or based on detection of an object along the road.

The vehicle control system may collect section information about each of a plurality of sections included in the road in operation 440. The vehicle control system may divide the road into the plurality of sections. The vehicle control system may combine each of the plurality of sections with the road feature to collect the section information about each of the plurality of sections. The section information may include at least one movement depiction of the vehicle and/or at least one road feature relative to the section of the road. The vehicle control system may collect the section information including the movement depiction calculated in operation 410 and the road feature determined in operation 430.

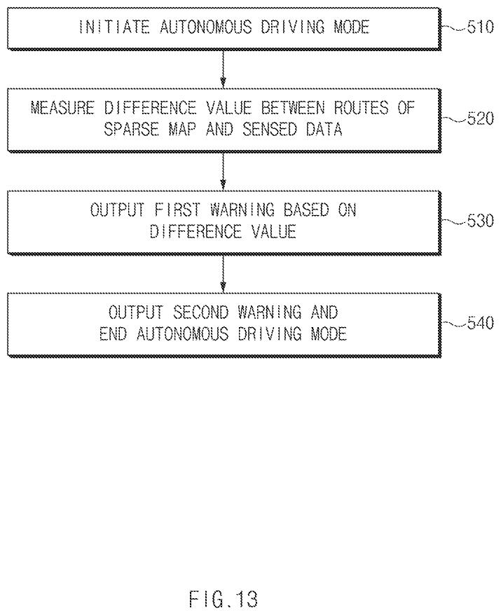

FIG. 13 is a flowchart showing a method in which a vehicle control system according to one embodiment of the present disclosure compares a trajectory generated using a road navigation model with sensed data and controlling an autonomous driving mode based on the comparing result.

The vehicle control system may apply the sparse map to an autonomous vehicle road navigation model. When using a previously stored sparse map, additional determination is required when a road environment has varied. For example, when a sparse map is created on a straight road, a drive route may change to a bypass road due to an event on the road such as construction In this way, when driving an actual road, the trajectory may be changed, and a notification about the change of the trajectory and/or a notification about whether autonomous driving is terminated may be provided.

The vehicle control system may initiate an autonomous driving mode in operation 510. When the vehicle drives in the autonomous driving mode, the vehicle control system may drive the vehicle based on navigation set based on the sparse map. The vehicle control system may drive the vehicle with referring to a line-related signal actually sensed by a front camera of the vehicle.

The vehicle control system may measure a difference value between routes of the sparse map and the sensed data in operation 520. The vehicle control system may measure each of a curvature of a route recognized using the sparse map and a curvature of a route recognized using the sensed data. The curvature may be expressed in a unit of R which is a reciprocal of m. The vehicle control system may measure a difference value between the curvature value of the route recognized by the sparse map and the curvature value of the route recognized using sensed data. For example, when the curvature value of the route recognized using the sparse map is 2000R and the curvature value of the route recognized using the sensed data is 1900R, the vehicle control system may calculate the difference value between the routes of the sparse map and the sensed data as 100R.

The vehicle control system may recognize the recognized route as a curved road when the curvature of the recognized route is smaller than or equal to a specified value. The vehicle control system may recognize the recognized route as a straight road when the curvature of the recognized route is greater than the specified value. For example, the vehicle control system may recognize the recognized route as a curved road when the recognized route has a curvature of 3000R or smaller.

The vehicle control system may output a first warning based on the difference value in operation 530. The vehicle control system may output the first warning when the difference value is greater than or equal to a first threshold value. The first threshold value may be 500R. For example, when the curvature value of the route recognized using the sparse map is 1000R and the curvature value of the route recognized using the sensed data is 500R, the vehicle control system may output the first warning because the difference value between the routes of the sparse map and the sensed data is 500R.

The vehicle control system may output the first warning when a type of the route recognized using the sparse map and a type of the route recognized using sensed data are different from each other. The first threshold value may be 500R. For example, when the route recognized using the sparse map is a straight road with a curvature of 3100R and the route recognized using the sensed data is a curved road with a curvature of 2900R, the vehicle control system may output the first warning because the type of the route recognized using the sparse map and the type of the route recognized using sensed data are different from each other.

The vehicle control system may output the first warning in a pop-up form to an output device such as a cluster of the vehicle to provide a visual warning notification to the driver. The first warning may include content that it is difficult to maintain current autonomous driving due to change in the surrounding road environment. For example, the vehicle control system may output a pop-up to the cluster saying, “Switch to a manual driving mode is required due to change in a surrounding road environment”.

The vehicle control system may output a second warning and end the autonomous driving mode in operation 540. The vehicle control system may output the second warning when the user input does not exist after outputting the first warning. The vehicle control system may output the second warning when the current autonomous driving mode is maintained after outputting the first warning. The second warning may be warning having a higher level than that of the first warning. For example, in order to output the second warning, the vehicle control system may output pop-up warning “switch to a manual driving mode” to the cluster and output an audible warning sound at the same time. After outputting the second warning, the vehicle control system may exit the autonomous driving mode and switch to a manual driving mode based on the user input. The vehicle control system may detect that the autonomous driving mode cannot be maintained due to change in the surrounding environment, may inform the driver that the autonomous driving mode should be terminated, and may terminate the autonomous driving mode based on the user input.

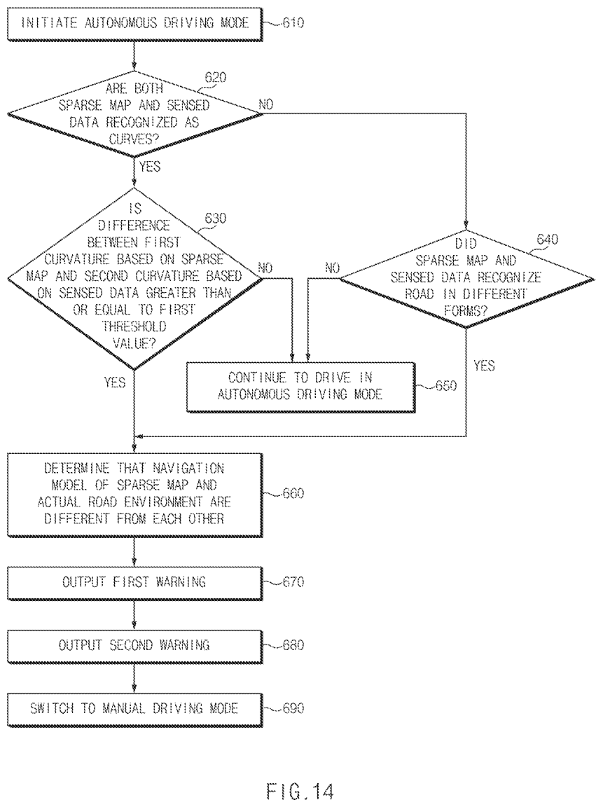

FIG. 14 is a flowchart showing a method in which a vehicle control system according to one embodiment of the present disclosure compares a route recognized using a sparse map with a route recognized using sensed data and controlling an autonomous driving mode based on the comparing result.

The vehicle control system may initiate the autonomous driving mode in operation 610.

The vehicle control system may identify whether or not both the sparse map and the sensed data are recognized as curves in operation 620. The vehicle control system may identify whether both a route recognized using the sparse map and a route recognized using the sensed data are curves. When the vehicle control system identifies that both the sparse map and the sensed data are recognized as curves in operation 620 (operation 620—YES), the vehicle control system may proceed to operation 630. When the vehicle control system identifies that at least one of the sparse map and the sensed data is recognized as a straight line in operation 620 (operation 620—NO), the vehicle control system may proceed to operation 640.

The vehicle control system may identify whether a difference between a first curvature based on the sparse map and a second curvature based on sensed data is greater than or equal to a first threshold value in operation 630. The first curvature may be a forward road curvature of the sparse map. The second curvature may be a forward road curvature based on forward camera sensing data. The first threshold value may be 500R. When the difference between the first curvature based on the sparse map and the second curvature based on the sensed data is greater than the first threshold value in operation 630 (operation 630—YES), the vehicle control system may proceed to operation 660. When the difference between the first curvature based on the sparse map and the second curvature based on the sensed data is smaller than the first threshold value in operation 630 (operation 630—NO), the vehicle control system may proceed to operation 650.

The vehicle control system may identify whether the sparse map and the sensed data recognize the road in different forms in operation 640. The vehicle control system may identify whether the sparse map and the sensed data recognize the same road in different forms such as a straight road and a curved road. The vehicle control system may proceed to operation 660 when the sparse map and the sensed data recognize the road in the different forms in operation 640 (operation 640—YES). When the vehicle control system identifies that the sparse map and the sensed data recognize the road in the same form in operation 640 (operation 640—NO), the vehicle control system may proceed to operation 650.

The vehicle control system may continue to drive in the autonomous driving mode in operation 650. The vehicle control system may determine that the route according to the sparse map matches the route according to the sensed data and thus may maintain a current autonomous driving mode.

The vehicle control system may determine that a navigation model of the sparse map and an actual road environment are different from each other in operation 660. The vehicle control system may determine that the actual road environment is different from information stored in the sparse map due to change in the external environment such as road construction.

The vehicle control system may output a first warning in operation 670. The vehicle control system may display a warning visually on the vehicle's output device.

The vehicle control system may output a second warning in operation 680. The vehicle control system may output a warning with a higher level than the first warning visually and audibly on the vehicle's output device. The vehicle control system may output the second warning when the user input does not exist after outputting the first warning.

The vehicle control system may switch to a manual driving mode in operation 690. The vehicle control system may exit the autonomous driving mode and initiate the manual driving based on the user input.

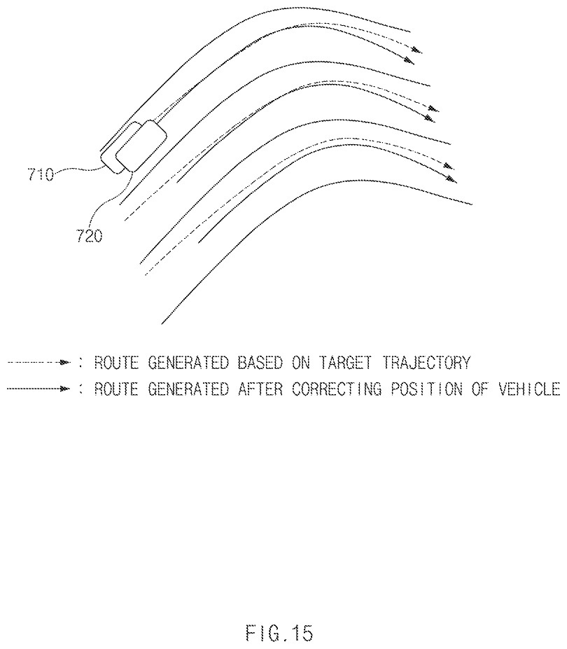

FIG. 15 is a diagram showing that the vehicle control system according to one embodiment of the present disclosure corrects a route generated based on a target trajectory, based on a vehicle position.

The vehicle control system may set, as a target trajectory, a trajectory along which the vehicle travels when the vehicle is positioned at a reference position 710. The vehicle control system may generate a route along which the vehicle wants to drive based on the target trajectory.

The vehicle control system may detect a current position 720 of the vehicle. The vehicle control system may correct the route created based on the target trajectory according to the current position 720 of the vehicle. The vehicle control system may control the vehicle to drive along the corrected route.

In particular, in an existing autonomous driving technology, when generating a plurality of routes using some target trajectories in a road having a plurality of lines, only an offset amount of a line is taken into consideration to generate the plurality of routes. Thus, the plurality of routes may have an error that a line offset of a previous target trajectory had in a non-corrected manner and there is a possibility that the error value becomes larger in a process of generating the plurality of routes.

When generating a plurality of routes using some target trajectories in a road having a plurality of lines, the vehicle control system generates the plurality of routes in a corrected state such that the vehicle is positioned in a median of a lane, thereby reducing an error occurring when generating the plurality of routes.

The vehicle control system may calculate the target trajectory, a width of the lane, and a current position of the vehicle on the lane. The vehicle control system may calculate the current position of the vehicle based on vehicle specifications. The vehicle control system may calculate a distance from a center of the vehicle to a left line, a distance from the center of the vehicle to a right line, and a width of the lane using the sensor.

The vehicle control system may perform a correction operation to correct a calculated current position of the vehicle to the median of the lane. The vehicle control system may perform the correction operation such that the corrected position of the vehicle is spaced from both side lines by the same spacing. The vehicle control system may correct the position of the vehicle so that the vehicle is spaced from each of both side lines by a value obtaining by adding the distance from the center of the vehicle to the left line and the distance from the center of the vehicle to the right line to each other and then dividing the adding result by 2.

The vehicle control system may generate the target trajectory based on an exact median in the lane as the corrected position of the vehicle. The vehicle control system may generate the plurality of routes based on the vehicle's position and the target trajectory. The vehicle control system may generate the plurality of routes with a reduced error by following the median of the lane rather than generating the plurality of routes based on the target trajectory generated to be biased toward one side line. The vehicle control system may generate each of the plurality of routes for each of lines included in the lane.

The vehicle control system according to the present disclosure may improve accuracy of a travel route on which the vehicle is to drive.

In addition, various effects directly or indirectly identified via the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control system comprising:
a processor configured to process data related to driving of a vehicle;
an input device for receiving a user input for controlling a driving function of the vehicle;
a sensing device for acquiring data related to the driving of the vehicle from the vehicle and an external environment; and
an output device for providing information related to the driving of the vehicle,
wherein the processor is configured to:
initiate an autonomous driving mode;
measure a difference value between a route of a sparse map and a route of a sensed data acquired using the sensing device;
control the output device to output a first warning based on the difference value; and
control the output device to output a second warning having a higher level than a level of the first warning, and end the autonomous driving mode based on the user input.

2. The system of claim 1, wherein the system further comprises:
an imaging device for sensing and imaging the external environment; and
a vehicle controller configured to control the driving of the vehicle.

3. The system of claim 1, wherein the processor is configured to measure each of a curvature of a route recognized using the sparse map and a curvature of a route recognized using the sensed data.

4. The system of claim 3, wherein when the curvature is smaller than or equal to a specified value, the processor is configured to determine the recognized route as a curved road; or
when the curvature is greater than the specified value, the processor is configured to determine the recognized route as a straight road.

5. The system of claim 1, wherein when the difference value is greater than a first threshold value, the processor is configured to control the output device to output the first warning.

6. The system of claim 1, wherein when a type of a route recognized using the sparse map and a type of a route recognized using the sensed data are different from each other, the processor is configured to control the output device to output the first warning.

7. The system of claim 1, wherein the processor is configured to control the output device to output the first warning in a pop-up form on a cluster of the vehicle.

8. The system of claim 1, wherein when the user input does not exist after outputting the first warning, the processor is configured to control the output device to output the second warning.

9. The system of claim 7, wherein the processor is configured to control the output device to output the second warning onto the cluster in order to output the second warning and at the same time, to output a warning notification sound in an audio manner.

10. A vehicle control system comprising:
a processor configured to process data related to driving of a vehicle; and
a vehicle controller configured to control the driving of the vehicle,
wherein the processor is configured to:
when the vehicle is positioned at a reference position, set a trajectory along which the vehicle travels as a target trajectory;
detect a current position of the vehicle;
correct the current position of the vehicle such that the vehicle is positioned at a median of a lane; and
generate a plurality of routes based on the corrected position of the vehicle and the target trajectory.

11. The system of claim 10, wherein the processor is configured to calculate a width of the lane.

12. The system of claim 10, wherein the processor is configured to calculate the current position of the vehicle based on specifications of the vehicle.

13. The system of claim 10, wherein the system further comprises a sensing device for acquiring data related to the driving of the vehicle from the vehicle and an external environment,
wherein the processor is configured to calculate a distance from a center of the vehicle to a left line and a distance from the center of the vehicle to a right line using the sensing device.

14. The system of claim 13, wherein the processor is configured to correct the current position of the vehicle so that the vehicle is spaced from each of the left and right lines by a spacing value obtained by adding the distance from the center of the vehicle to the left line and the distance from the center of the vehicle to the right line to each other and dividing the adding result by 2.

15. The system of claim 10, wherein the processor is configured to generate each of the plurality of routes for each of lines included in the lane.

16. A method for driving a vehicle using a vehicle control system, the method comprising:
initiating an autonomous driving mode;
measuring a difference value between a route of a sparse map and a route of sensed data acquired using a sensing device of the vehicle control system;
controlling an output device of the vehicle control system to output a first warning based on the difference value; and
controlling the output device to output a second warning having a higher level than a level of the first warning, and ending the autonomous driving mode.

17. The method of claim 16, wherein the measuring of the difference value includes:
measuring each of a curvature of a route recognized using the sparse map and a curvature of a route recognized using the sensed data.

18. The method of claim 17, wherein the measuring of the difference value includes:
when the curvature is smaller than or equal to a specified value, determining the recognized route as a curved road; and
when the curvature is greater than the specified value, determining the recognized route as a straight road.

19. The method of claim 16, wherein the controlling of the output device to output the first warning includes:
when the difference value is greater than or equal to a first threshold value, outputting the first warning.

20. The method of claim 16, wherein the controlling of the output device to output the first warning includes:
when a type of a route recognized using the sparse map and a type of a route recognized using the sensed data are different from each other, outputting the first warning.
